(19) United States
(12) Patent Application Publication
(10) Pub. No.: US 2017/0084366 A1
(43) Pub. Date: Mar. 23, 2017

(54) RESISTOR

(71) Applicant: YAGEO CORPORATION, Kaohsiung City (TW)

(72) Inventors: Dong-Mou TSAI, Kaohsiung City (TW); Sheng-Li HSIAO, Kaohsiung City (TW); Shih-Hsin CHANG, Kaohsiung City (TW); Chih-Lung CHEN, Kaohsiung City (TW); Hwan-Wen LEE, Kaohsiung City (TW)

(73) Assignee: YAGEO CORPORATION, Kaohsiung City (TW)

(21) Appl. No.: 15/056,736

(22) Filed: Feb. 29, 2016

(30) Foreign Application Priority Data
Sep. 23, 2015 (TW) 104215362

(51) Int. Cl. H01C 7/00

(52) U.S. Cl. CPC H01C 7/00

(57) ABSTRACT

A resistor includes a body and two connecting members. The body is made from an ohmic material and has two opposite side faces. Each of the connecting members has a side surface that has a connecting region welded to a respective one of the side faces of the body.

### CROSS-REFERENCE TO RELATED APPLICATION

This application claims priority of Taiwanese Application No. 104215362, filed on Sep. 23, 2015.

### FIELD

The disclosure relates to a resistor, more particularly to a resistor including a body and two connecting members that are welded to the body.

### BACKGROUND

Referring to FIGS. 1 and 2, a conventional resistor 1 is made from an alloy and is formed using a stamping technique. The conventional resistor 1 includes a body 11, two shoulder parts 12 that respectively and downwardly extend from two opposite ends of the body 11, and two connecting members 13 that respectively and laterally extend from the shoulder parts 12. The connecting members 13 may be soldered onto an electronic device (not shown), so that the conventional resistor 1 offers a predetermined resistance when an electric current passes therethrough.

Since the overall resistance value of a metal or an alloy is affected by its shape and curvature, the configuration of the arc-shaped shoulder parts 12 is a factor that affects the overall resistance value of the conventional resistor 1. During mass production, dimensional tolerance of the shoulder parts 12 undesirably leads to variations of the overall resistance values of the conventional resistors 1.

In addition, the conventional resistor 1 is usually small in size. A specification of the conventional resistor 1, which specifies a height (h1) from the connecting members 13 to the body 11 equal to 0.5±0.15 mm with a tolerance limit of 1%, is relatively difficult to achieve due to tolerance limitations of the stamping technique.

### SUMMARY

Therefore, an object of the disclosure is to provide a resistor that can alleviate at least one of the drawbacks of the prior art.

According to the disclosure, the resistor includes a body and two connecting members. The body is made from an ohmic material and has two opposite side faces. Each of the connecting members has a side surface that has a connecting region welded to a respective one of the side faces of the body.

### BRIEF DESCRIPTION OF THE DRAWINGS

Other features and advantages of the disclosure will become apparent in the following detailed description of the embodiments with reference to the accompanying drawings, of which:

FIG. 1 is a schematic view illustrating a conventional resistor;

FIG. 2 is a side view illustrating the conventional resistor;

FIG. 3 is a schematic view illustrating a first embodiment of a resistor according to the disclosure;

FIG. 4 is a side view illustrating the first embodiment;

FIG. 5 is a schematic view illustrating a second embodiment of a resistor according to the disclosure; and

FIG. 6 is a side view illustrating the second embodiment.

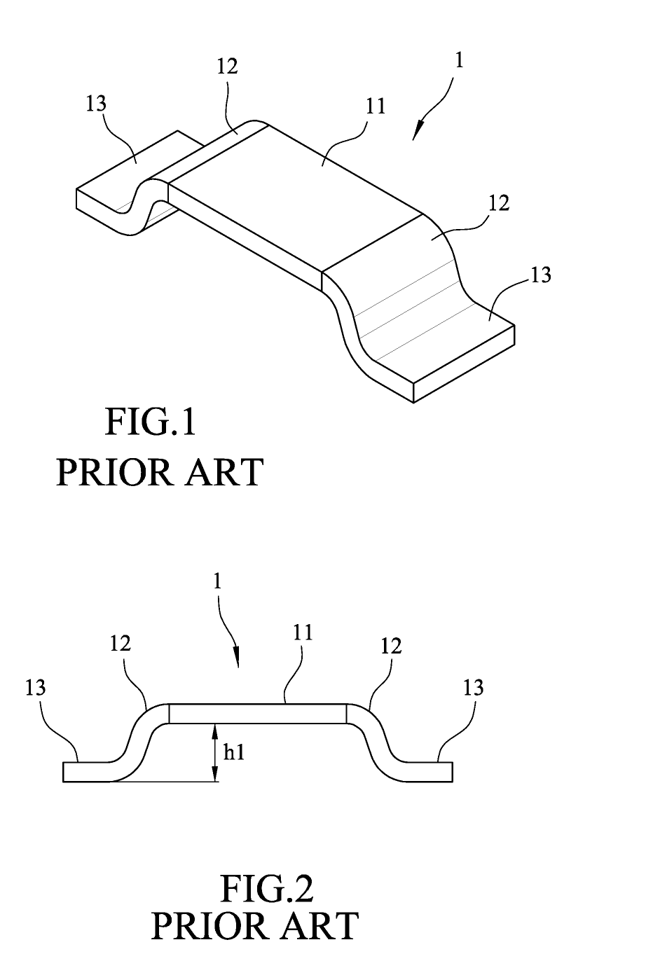

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

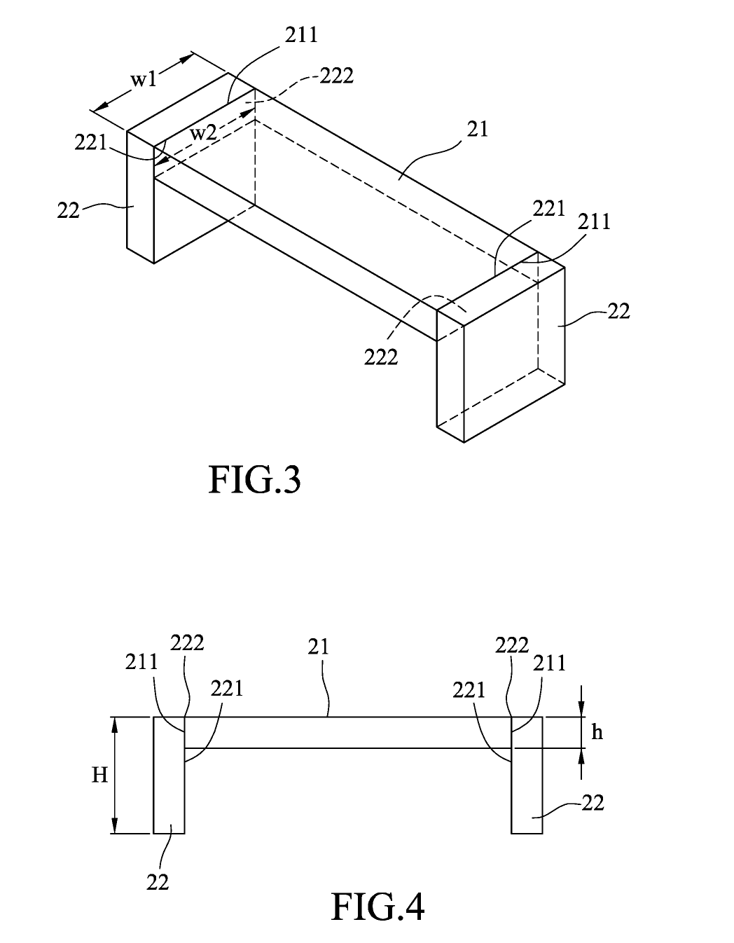

Referring to FIGS. 3 and 4, a first embodiment of a resistor according to this disclosure is used on an electronic system (not shown) to offer resistance when an external electric current passes therethrough, and includes a body 21, and two connecting members 22.

The body 21 is made from an ohmic material and has two opposite side faces 211. In this embodiment, the body 21 is made from an alloy including iron, chromium, and aluminum.

In this embodiment, the body 21 is cuboid in shape, and each of the side faces 211 is rectangular in shape.

Each of the connecting members 22 has a side surface 221 that has a connecting region 222 welded to a respective one of the side faces 211 of the body 21. The connecting region 222 of each of the connecting members 22 completely overlaps a respective one of the side faces 211 of the body 21. In this embodiment, the connecting members 22 are made from an alloy including copper, and each of the connecting members 22 is cuboid in shape. The side surface 221 of each of the connecting members 22 is rectangular in shape. In this embodiment, each of the side faces 221 has a first width (w1), and the connecting region 222 of the side surface 221 of each of the connecting members 22 has a second width (w2) that is identical to the first width (w1).

More specifically, the connecting region 222 of the side surface 221 of each of the connecting members 22 is welded to the respective one of the side faces 211 of the body 21 using an electron beam welding technique. In a process of performing the electron beam welding technique, a plurality of electrons are first emitted from a cathode of a heating filament in a vacuum chamber. Then, the emitted electrons are accelerated under a voltage ranging from 30 KV to 200 KV, and are passed through an electromagnetic lens to be concentrated into an electron beam that has a power density ranging from 105 W/cm² to 109 W/cm². The electron beam can be used for welding by transforming kinetic energy into thermal energy, thereby achieving precise welding.

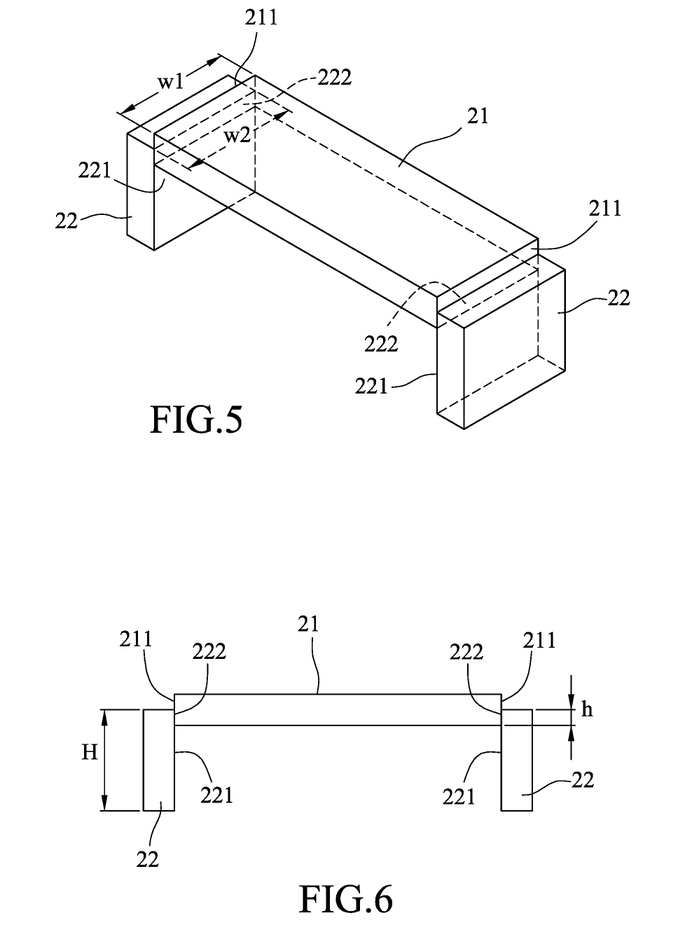

Referring to FIGS. 5 and 6, a second embodiment of the resistor according to this disclosure is similar to the first embodiment except that the connecting region 222 of each of the connecting members 22 overlaps a part of the respective one of the side faces 211 of the body 21 so that the connecting region 222 of each of the connecting members 22 has an area smaller than that of the respective one of the side faces 211 of the body 21. The resistance of the second embodiment may be controlled by changing the area of each of the connecting regions 222. In one embodiment, the side surface 221 of each of the connecting members 22 has a first length (H) perpendicular to the second width (w2), and the connecting region 222 of the side surface 221 of each of the connecting members 22 has a second length (h) perpendicular to the second width (w2). In order to facilitate welding of the connecting members 22 of the resistor onto a targeted piece of electronic equipment (e.g., a printed circuit board), and to avoid the body 21 being too thick, a ratio of the second length (h) to the first length (H) is controlled to be smaller than 1 and greater than 0.6.

In practical use, the resistor of this disclosure is electrically connected to the targeted electronic equipment. When an electric current subsequently flows through one of the connecting members 22, the body 21, and the other one of the connecting members 22, a desired resistance is offered by the resistor.

To sum up, in this disclosure, the connecting members 22 are connected to the body 21 by a welding technique such as the electron beam welding technique, thereby achieving precise and automated manufacturing of the resistor. Furthermore, the body 21 and the connecting members 22 are not deformed during manufacturing, thereby eliminating the drawbacks associated with the conventional stamping technique, and achieving precise control of the resistance value of the resistor.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A resistor comprising:
a body made from an ohmic material and having two opposite side faces; and
two connecting members, each of which has a side surface that has a connecting region welded to a respective one of said side faces of said body.

2. The resistor as claimed in claim 1, wherein said connecting region of said side surface of each of said connecting members is welded to a respective one of said side faces of said body using an electron beam welding technique.

3. The resistor as claimed in claim 2, wherein said body and said connecting members are each cuboid in shape.

4. The resistor as claimed in claim 3, wherein said body is made from an alloy including iron, chromium, and aluminum.

5. The resistor as claimed in claim 3, wherein said connecting members are made from an alloy including copper.

6. The resistor as claimed in claim 3, wherein each of said side faces is rectangular in shape, said connecting region of said side surface of each of said connecting members being rectangular in shape.

7. The resistor as claimed in claim 6, wherein each of said side faces has a first width, said connecting region of said side surface of each of said connecting members having a second width that is identical to the first width.

8. The resistor as claimed in claim 7, wherein each of said side surfaces has a first length perpendicular to the second width, said connecting region of said side surface of each of said connecting members having a second length perpendicular to the second width, a ratio of the second length to the first length (H) being smaller than 1 and greater than 0.6.
